(19) United States
(12) Patent Application Publication
(10) Pub. No.: US 2015/0354777 A1
(43) Pub. Date: Dec. 10, 2015

(54) DECORATIVE FIXTURE

(71) Applicant: Julie CLAIRE, (US)

(72) Inventor: Julie Claire, Torquay, Devon (GB)

(21) Appl. No.: 14/759,914

(22) PCT Filed: Jan. 7, 2014
(86) PCT No.: PCT/GB2014/050029

§ 371 Date: Jul. 8, 2015

(30) Foreign Application Priority Data
Jan. 8, 2013 (GB) 1300263.9

(51) Int. Cl. F21V 1/04

(52) U.S. Cl. CPC F21V 1/04

(57) ABSTRACT

According to the present invention there is provided a decorative fixture for through-light comprising a first upper layer and a second lower layer. The first upper layer is arranged in use to be located proximal to a light source and said second layer is arranged in use to be located distal to a light source. The layers are arranged in use to mutually define a space which is arranged in use to receive a plate. The fixture further comprises a securement means. One of said layers is arranged in use to be suspended from a surface by said securement means.

### FIELD OF THE INVENTION

The present invention relates to a decorative fixture, more particularly but not exclusively a decorative fixture to be used in close cooperation with or arranged integrally with an illuminating light source.

### BACKGROUND

Lighting or light sources are used in everyday situations to improve visibility, to change an ambiance of a room or to serve as a decoration.

Often lighting is provided by fitted ceiling or wall lights, or portable lamps. Either of these types of light fixtures may be provided with dimming facility and different colours and furthermore in combination or alone, portability allows greater flexibility in lighting.

Often however if a room is redecorated lighting or light fixtures must be changed, as over time a particular style may become outdated and therefore replacement may be desirable. This can lead to large expense, particularly in plural situations, for example such as hotels.

The present invention arose to overcome the inflexibility and similar problems associated with standard lighting fixtures.

### PRIOR ART

Accordingly a number of patent applications have been filed in an attempt to resolve the problem or similar, including the following:

International patent application WO 2011 159 141 (ESPINOSA) discloses a method for producing decorative or artistic panels on glass surfaces and multilayer polymer surfaces, and the use thereof in commercial and artistic decor as partition walls, ceilings, picture frames, sculptures, floor lamps, table lamps or ceiling lights, billboards, domes, stained glass windows, shower partitions, and for decorating spaces in the home and in industry.

Chinese utility model CN 201 731 296 (CHUNRONG et al) discloses an LED (light-emitting diode) art lamp, belonging to a lighting device. In the prior art, in order to achieve the purposes of lighting and decoration, a floodlight and a decoration need to be installed on a wall or a roof simultaneously, so that large space is occupied, and arrangement is messy. The LED art lamp comprises a panel, and a transparent plate, an LED circuit board and a rear cover plate which are sequentially arranged at the rear side of the panel and fixedly connected with the panel. The LED art lamp is characterized in that the transparent plate is provided with artistic patterns so as to achieve the purposes of lighting and highlighting the artistic patterns when LEDs on the LED circuit board emit light, thus playing a role in artistic decoration, occupying small space and being messy in arrangement. The LED art lamp can be hung on the wall and other positions as a mural, and also can be installed on the roof (indoor suspended ceiling) and other positions as a ceiling lamp for lighting and decoration simultaneously.

Granted U.S. Pat. No. 7,222,449 (GOURAND et al) discloses a display device for exhibiting pictures on a wall or other surface comprising: an elongated substrate member being supplied in a roll-type form, and adapted to be used as a border member on a wall or other surface, the substrate member having a definite length and a definite height; said substrate member having a front surface and a rear surface, said rear surface of said substrate member having an adhesive material thereon for securing said substrate member to a wall or other surface; said front surface of said substrate member having a pictorial design along the length thereof; and a plurality of picture pockets secured to said substrate member at predetermined intervals along the length thereof; said picture pockets being made of a transparent material and having an opening therein for insertion of pictures or other display materials; wherein when said elongate substrate member is unrolled and secured to a wall or other surface as a border member, said substrate member provides a pictorial design and a plurality of transparent pockets, and wherein when pictures or other display materials are inserted into said picture pockets, said pictures or other display materials are held in place and visible through the transparent material, and when there are no pictures or other display materials in said pockets, the pictorial design on the substrate member is visible through the transparent material.

In contrast the present invention provides a simple means to flexibly and repeatedly allow changes in ambience and effect of a bespoke lighting fixture or in other embodiments a standard lighting fixture, so requiring no expensive retreatment of a lighting situation when change is to be welcomed.

### SUMMARY OF THE INVENTION

According to the present invention there is provided a decorative fixture for through-light comprising a first upper layer and a second lower layer, in which said first upper layer is arranged in use to be located proximal to a light source and said second layer is arranged in use to be located distal to a light source, said layers are arranged in use to mutually define a space which is arranged in use to receive a plate, and a securement means, in which one of said layers is arranged in use to be suspended from a surface by said securement means.

The layers may be arranged to mutually define a space in a fixed ratio.

Typically the layers are fastened together in use, and said space extends substantially or wholly parallel to the layers.

Typically therefore the decorative fixture or light fixture is envisaged to be provided in embodiments further comprising: at least one panel or layer, wherein a removable typically translucent or transparent image or decoration is displayed through the panel or layer and wherein said panel or layer is capable of being illuminated.

In preferred embodiments the light fixture is illuminated by the light source that highlights the image/decoration associated with the fixture, wherein the light source may be integrated or external.

Where external or independent typically the fixture is positioned proximate or integral to said light source and the light source illuminates by passing light through the fixture, wherein for example the fixture may be positioned on top of, covering or over the light source, such as below lights mounted on a ceiling or in front of lights mounted on a wall.

Said securement means may typically comprise: a housing or at least one arm adapted to elevate the fixture from the surface. For example the housing may contain, and for example hide the light source and/or the arm(s) and be arranged in use to allow passage of light from the light source in other directions. The housing may be arranged in use to allow air flow.

Where the light source is internal or integral the fixture may house lighting means such as light emitting diodes (LEDs) or an electroluminescent sheet which illuminates the fixture for example transmitted through the upper layer.

It may be envisaged that the light source provided for the fixture, whether internal or external, may be varied, or variable, wherein for example brightness may be altered by a dimmer, the light may be coloured, constant or intermittent. Where variations exist ideally said variations will be reflected in or cooperative with the fixture.

Preferably the layers are planar and may be typically square or rectangular, formed from a durable transparent and/or translucent material such as Perspex (Trade Mark), acrylic glass or glass.

In some embodiments at least one of the layers may be offset, curved or angled with respect to the light source or surface, wherein the light source may be deflected, diffused or hidden according to such orientation.

In preferred embodiments the layer edges are preferably straight with a rounded or bevelled finish, to avoid sharp edges capable of damaging the plate during insertion or changing. In some embodiments the edges or edging may be multi angled or for example serrated. It is envisaged that the edging may vary from one layer side to another, for example two opposite sides may have bevelled edges and the other edges may be rounded.

Said edging may in some embodiments be envisaged to have effect on the illumination properties of the layers wherein for example in some embodiments where the light source is at least partly introduced edgewise, the edge(s) may diffuse or transmit the light source according to the edge profile.

In some embodiments the layers may be embossed, etched or otherwise adorned with decoration to further alter light source transmission.

In preferred embodiments in any event the plate is provided on an at least partly transparent material and positioned intermediate, adjacent or contiguous to the layers wherein said layers and plates are largely equivalent in size and dimensions. In some embodiments the image may be printed directly on to the layer, although further embodiments may include partially sized plates for example in plural use with larger layers. The invention is to be read to include a method of producing plates for such use according to a second aspect.

In preferred embodiments two layers sandwich the plate in use, although further embodiments may be envisaged with a greater number of layers and/or plural plates, acting incrementally or progressively to alter the light source in use.

Preferably at least one of the layers is partly or wholly transparent so as to reveal the plate sandwiched beneath and enable useful illumination

Typically the layer closest to the light source, be that light source external or internal, situate sidemost or rearmost, comprises a layer arranged so as to direct, dissipate or diffuse light provided from the light source. Advantageously this diffusion assists in concealing the light source for example wiring.

In some embodiments the layers or at least the layer closest to the light source may be thereby domed or otherwise arranged so as to define or surround a lacuna.

Ideally the two layers are arranged in use to be removably attached to one another for example the layers may include a plurality of apertures, for example one in each corner of the layer, so as to accept a bolt to secure the two layers together.

Alternatively the layers may be arranged in use to be clamped together wherein a clamp is placed around the edges so as to hold them together.

In some other embodiments the layers may be glued together with an adhesive, preferably a clear adhesive so as to be discrete and including or arranged with a pocket wherein the layers are formed accordingly.

It may be envisaged that at least one spacer may be provided, said spacer(s) being arranged in use to be provided between the layers so as to provide a slot into which the plate may be accepted and removed without requirement for the layers to be separated. Advantageously the spacer(s) may be transparent, and/or typically formed from the same or similar material as the layers.

In preferred embodiments the spacers may include or comprise attachment means between the layers, for example wherein the spacers comprise magnetic portions for mutual magnetic engagement. Yet further embodiments of the spacers may comprise mutually corresponding engagement sections or profiles, reliant for example on detent mechanism, tolerance, friction or clip fitting. These spacers ideally are dispersed about the layers, and may be used in further embodiments with displaceable portions or variant characteristics, for example in order to facilitate mutual fastening of the layers at some of the spacers only.

In other embodiments at least one layer may include a recess on an inside face in use so as to provide a slot or pocket into which the plate may be added or inserted.

In some other embodiments one layer may include a pocket for accepting the transparency therefore removing requirement for the second layer to sandwich the plate.

Typically the layers may include apertures which accept a fitting such as a screw or nut and bolt to enable the light fixture to be attached to the surface. In some embodiments means of attachment may be integrated with the layers.

Ideally the fixture also includes at least one arm to space the fixture from the surface on which they are placed thereby creating a void between the surface and the layer(s).

It may be further envisaged that the fixture may be used individually or as part of a collection, for example the same image printed in different colourways or a whole image may be shown on collections of individual layers or fixtures positioned so that in use a mosaiced whole image is displayed.

In some embodiments the fixture may be used to represent a window or skylight in a room that does not have views or receive limit light.

In yet further embodiments the fixtures may be used as feature items such as a shower screen or room divider. It is envisaged the light fixture may also be adapted for outside use.

### BRIEF DESCRIPTION OF FIGURES

FIG. 1 shows an isometric view of an embodiment of the invention;

FIG. 2 shows an isometric view of a second embodiment;

And

FIG. 3 shows a side view of a detail of an embodiment relating to fitting.

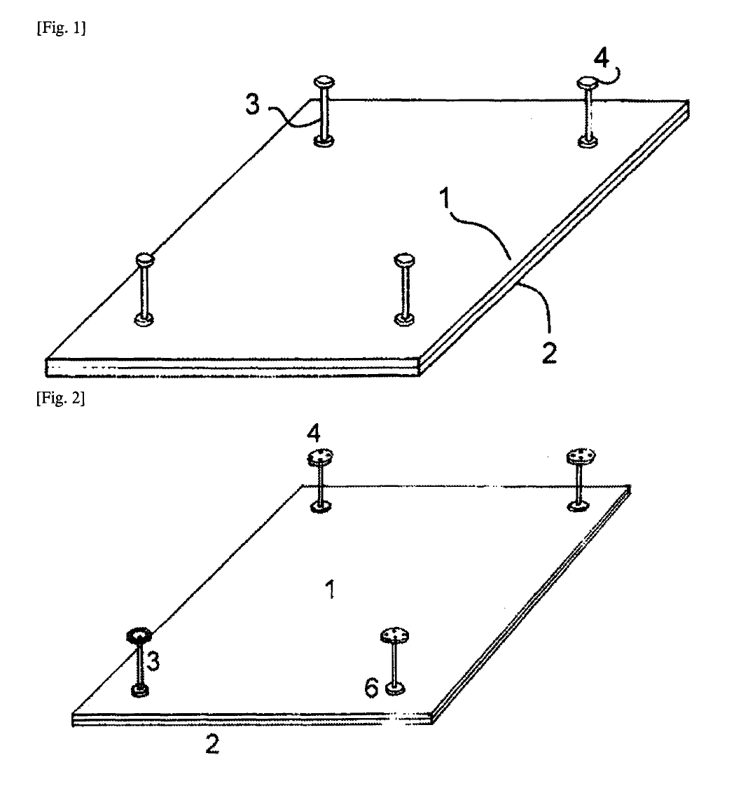

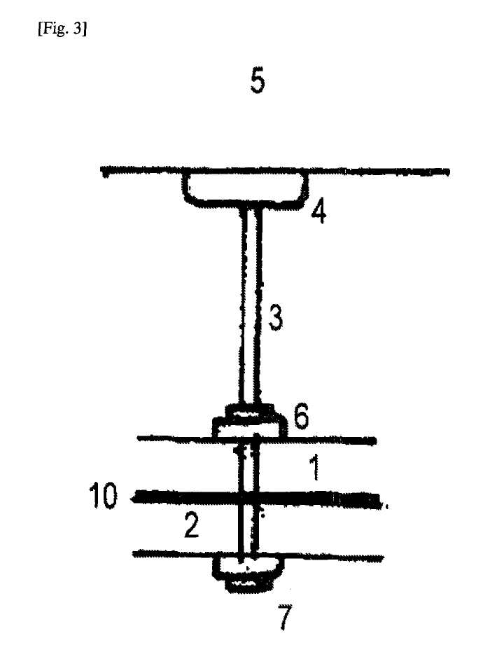

### DETAILED DESCRIPTION OF FIGURES

With reference to the figures an upper layer 1 is situate vertically superior in use to the lower layer 2 sandwich a plate 10, wherein the layers 1, 2 are held together by clamps 6, 7 on an arm 3, wherein said arm is secured to a surface 5 by use of a foot 4.

In further embodiments upper and lower do not denote vertical, merely proximity to the light source and may be reversible between embodiments.

In order to provide the securement means said arm may provide a screw thread at least in part wherein the clamps 6, 7 are enabled to move together to clamp the layers 1, 2 in use. In other embodiments the arm 3 includes screwthreading for the lowermost or outermost clamp 7 alone.

Said foot 4 may be screwed or nailed to the surface 5 using any fitting suitable to the hold weight of the layers 1 and 2 and appropriate for the construct of the ceiling.

Preferably the layers' 1, 2 shortest side is at least 30 cm and ideally no greater than 300 cm. Typically the layers 1, 2 may be provided in predetermined sizes although dimensions may be varied to fit a particular space and modular and/or user defined or cut sizes may be envisaged in some embodiments.

The invention has been described by way of examples only and it will be appreciated that variation may be made to the above-mentioned embodiments without departing from the scope of invention.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A decorative fixture for through-light comprising a first upper layer and a second lower layer, in which said first upper layer is arranged in use to be located proximal to a light source and said second layer is arranged in use to be located distal to a light source, said layers are arranged in use to mutually define a space which is arranged in use to receive a plate, and a securement means, in which one of said layers is arranged in use to be suspended from a surface by said securement means.

2. A fixture according to claim 1 wherein the layers are arranged in use to be fastened together.

3. A fixture according to claim 1 wherein said space extends substantially parallel to the layers.

4. A fixture according to claim 3 comprising a spacer between the layers formed from the same material as the layers.

5. A fixture according to claim 3 wherein the space provides a slot in which the plate may be accepted and removed.

6. A fixture according to claim 1 wherein the first upper layer and the second lower layer are arranged to be removably attached from one another.

7. A fixture according to claim 1 wherein the first upper layer is arranged to diffuse light provided from the light source.

8. A fixture according to claim 1 wherein the fixture further comprises a light source.

9. A fixture according to claim 1 wherein the fixture is independent to a light source.

10. A fixture according to claim 1 wherein the securement means comprises at least one arm arranged in use to elevate the upper layer from the light source or surface.

11. A fixture according to claim 1 wherein the securement means comprises a housing to substantially enclose the light source.

12. A fixture according to claim 11 wherein the housing is adapted to hide the light source.

13. A fixture according to claim 1 wherein the light source is an electroluminescent sheet or light emitting diodes.

14. A fixture according to claim 1 further comprising the plate, wherein the plate is a removable translucent or transparent decoration.
